(19) United States
(12) Patent Application Publication
(10) Pub. No.: US 2025/0181837 A1
(43) Pub. Date: Jun. 5, 2025

(54) TEXT GENERATION METHOD AND APPARATUS, STORAGE MEDIUM, COMPUTER DEVICE, AND PROGRAM PRODUCT

(71) Applicant: Tencent Technology ( Shenzhen ) Company Limited, Shenzhen (CN)

(72) Inventor: Renqing Cheng, Shenzhen (CN)

(21) Appl. No.: 19/050,645

(22) Filed: Feb. 11, 2025

Related U.S. Application Data
(63) Continuation of application No. PCT/CN2023/131527, filed on Nov. 14, 2023.

(30) Foreign Application Priority Data
Feb. 13, 2023 (CN) 202310155833.4

(51) Int. Cl. G06F 40/30; G06F 16/334

(52) U.S. Cl. CPC G06F 40/30; G06F 16/3344

(57) ABSTRACT

A text generation method and apparatus, a storage medium, a computer device, and a program product are provided. The method may include performing similarity calculation on each interactive text pair in an interactive content library to obtain at least one target interactive text pair as an annotation example, the annotation example having a corresponding transformation style; performing semantic similarity retrieval in the annotation example based on text input to obtain a preset number of target annotation examples; constructing a prompt according to the target annotation example, a target style, and the text input, and inputting the prompt into a pretrained model for performing text extension to obtain at least one piece of predicted text; and performing score calculation on the at least one piece of predicted text to determine target text.

### RELATED APPLICATION

This application is a continuation application of PCT Application PCT/CN2023/131527, filed Nov. 14, 2023, which claims priority to Chinese Patent Application No. 202310155833.4 filed on Feb. 13, 2023, each entitled “TEXT GENERATION METHOD AND APPARATUS, STORAGE MEDIUM, COMPUTER DEVICE, AND PROGRAM PRODUCT”, and each which is incorporated herein by reference in its entirety.

### TECHNICAL FIELD

Aspects described herein relate to language processing, and more specifically, to text generation methods and apparatuses, a storage medium, a computer device, and a program product.

### BACKGROUND

In situations, an Internet product requires a human-machine interactive function in a conversation manner. When a user communicates with a machine using a language, the machine will generate corresponding interactive content based on speaking content of the user and provide feedback, including the interactive content, to the user. For example, in a scenario with a virtual human customer service and a game service, a virtual character of a servicing party (e.g., a game operator) may provide different interactive content (e.g., audio such as generated speech) to a user according to a service scenario.

Currently, existing interactive content generation methods and systems mainly relate to text paraphrasing and text style transfer. According to these methods, models configured for enriching interactive content are obtained by performing supervised learning based on a general corpus.

### BRIEF SUMMARY

Aspects described herein provide a text generation method and apparatus, and a storage medium, a computer device and a program product.

One or more aspects described herein provide a text generation method. The method may include: performing similarity calculation on each interactive text pair in an interactive content library to obtain at least one target interactive text pair as an annotation example, the annotation example having a corresponding transformation style, the corresponding transformation style being a transformation style between two pieces of interactive text in each target interactive text pair in the annotation example; performing semantic similarity retrieval in the annotation example based on text input to obtain a preset number of target annotation examples; constructing a prompt according to the target annotation example, a target style, and the text input, and inputting the prompt into a pretrained model for performing text extension to obtain at least one piece of predicted text, the target style being a style into which the text input is to be transformed; and performing score calculation on the at least one piece of predicted text to determine target text.

One or more aspects described herein further provide a text generation apparatus. The apparatus may include: an example obtaining module, configured to perform similarity calculation on each interactive text pair in an interactive content library to obtain at least one target interactive text pair as an annotation example, the annotation example having a corresponding transformation style, the corresponding transformation style being a transformation style between two pieces of interactive text in each target interactive text pair in the annotation example; an example selecting module, configured to perform semantic similarity retrieval in the annotation example based on text input to obtain a preset number of target annotation examples; a text generation module, configured to construct a prompt according to the target annotation example, a target style, and the text input, and input the prompt into a pretrained model for performing text extension to obtain at least one piece of predicted text, the target style being a style into which the text input is to be transformed; and a text determining module, configured to perform score calculation on the at least one piece of predicted text to determine target text.

In another aspect, a computer-readable storage medium may be provided. The computer-readable storage medium may store a computer program. The computer program performs the foregoing text generation method when executed by a processor.

In another aspect, a computer device may be provided. The computer device may include a processor and a memory. The memory may store a computer program. The computer program may be configured to perform a text generation method when invoked by the processor.

In another aspect, a computer program product may be provided. The computer program product may include a computer program. The computer program may be stored in a storage medium. A processor of a computer device may read the computer program from the storage medium. The processor may execute the computer program (e.g., computer readable instructions or code) to cause and/or enable the computer device to perform operations in the foregoing text generation method.

According to the text generation methods described herein, similarity calculation may be performed on each interactive text pair in an interactive content library to obtain at least one target interactive text pair as an annotation example; the annotation example may have a corresponding transformation style; semantic similarity retrieval may be performed on the annotation example based on text input to obtain a preset number of target annotation examples; a prompt may be constructed according to the target annotation example, a target style, and the text input, and the prompt may be input into a pretrained model for performing text extension to obtain at least one piece of predicted text; and then, score calculation may be performed on the at least one piece of predicted text to determine target text. Thus, the prompt may be constructed by a high-quality target annotation example selected from the interactive content library and different target styles can fully enable the model to better play contained knowledge about interactive content transformation, and guide the pretrained model to generate diversified interactive content. In addition, the pretrained model can generate the interactive content in a specified style in a targeted manner based on the target annotation example with a standardized template and a specified transformation style. Meanwhile, by virtue of performing score calculation on the predicted text, the generated interactive content can be prevented from semantically deviating from original interactive content, thereby effectively improving quality of interactive content generation.

### BRIEF DESCRIPTION OF THE DRAWINGS

To describe technical solutions of aspects provided herein, the following briefly introduces drawings required for describing those aspects. The drawings in the following descriptions are merely some aspects of this application, and for those skilled in the art, other drawings may be obtained according to these drawings without creative work.

FIG. 1 is a schematic diagram of an example system architecture according to one or more aspects described herein.

FIG. 2 is a schematic flowchart of an example text generation method according to one or more aspects described herein.

FIG. 3 is a schematic diagram of selecting a target annotation example according to one or more aspects described herein.

FIG. 4 is a schematic flowchart of another example generation method according to one or more aspects described herein.

FIG. 5 is an example application scenario of a text generation method according to one or more aspects described herein.

FIG. 6 is a schematic diagram of an example framework of interactive content enrichment according to one or more aspects described herein.

FIG. 7 is a block diagram of example modules of a text generation apparatus according to one or more aspects described herein.

FIG. 8 is a block diagram of example modules of a computer device according to one or more aspects described herein.

FIG. 9 is a block diagram of an example computer-readable storage medium according to one or more aspects described herein.

### DETAILED DESCRIPTION

Aspects of the disclosure are described in detail below, and examples are shown in accompanying drawings. The same or similar reference numerals represent the same or similar elements or elements having the same or similar functions throughout the description. The descriptions provided below with reference to the accompanying drawings are exemplary, and are only configured for explaining various aspects and are not to be construed as limiting.

In some processes described in the specification, the claims, and the foregoing accompanying drawings, a plurality of operations occurring in a specific sequence is included. However, these operations might not be performed in the particular sequence in which the operations occur in this specification or performed in parallel. The sequence numbers of the operations are merely for distinguishing different operations, and do not indicate any execution sequence. In addition, terms such as “first”, “second”, and the like herein are intended to distinguish similar objects rather than describing specific sequence or chronological order.

For ease of understanding, the following clearly describes the technical solutions with reference to the accompanying drawings. Apparently, the described aspects do not represent all possible aspects. All other aspects obtainable by those skilled in the art without creative work fall within the scope of protection of this application.

According to one or more aspects, relevant data such as an interactive content library, text input, and an annotation example may be involved. Accordingly, user permission or consent may need to be obtained when the relevant data is applied to a specific product or technology described herein, and collection, use, and processing of the relevant data need to comply with relevant laws, regulations, and standards of relevant countries and regions.

Interactive content may refer to content transmitted from a machine to a user when the user performs human-machine interactive by using a product, which may include forms such as voice, video, or text. Rich interactive content can provide a better experience for the user when interacting with the product, and can improve efficiency of human computer interactive. For example, in the field of games, a game product may broadcast a game policy to players in real time through voice broadcast (for example, fifth person (artificial intelligence) voice broadcast in a case where there are four game players). Broadcasting the same interactive content in the same game scenario all the time (e.g., at a high frequency) will affect a game experience of the player.

In view of this possible negative impact to the player experience, more and more products have started to pay attention to methods for enriching interactive content of human-machine interaction, such as for virtual human customer service and live streaming. Currently, an interactive content enriching method is mainly based on a text paraphrasing technology and a text style transfer technology. A text paraphrasing task is, for example, to rephrase a sentence/paragraph of text A into text B, and require the text B to express text having a meaning close to that of the text A in an expression manner slightly different from that of the text A. Text style transfer is intended to modify a specific style or attribute, such as a sentiment, a tense, or a gender, of text in a manner of editing or generating based on retaining text content.

However, most of text paraphrasing solutions involve or require supervised learning performed based on a corpus, and there is a relatively small amount of open source data configured for training. Accordingly, a text paraphrasing model obtained through training might not be accurate enough. In addition, the text paraphrasing model trained by using data in a general field might not perform well in a specific field. Secondly, diversity of text paraphrasing expression manners may be relatively poor, and may be limited to expression manners existing in training data. A model related to the text style transfer mainly focuses on enriching the interactive content in terms of transforming attributes such as sentiments, preferences, and expression habits, which might not be able to satisfy a desired or requisite diversity of enriching the interactive content of the product. Moreover, when the text paraphrasing technology and the text style transfer technology are applied to a specific field, generated new interactive content may easily deviate from the semantics of original interactive content, and the generated interactive content may thus have poor quality.

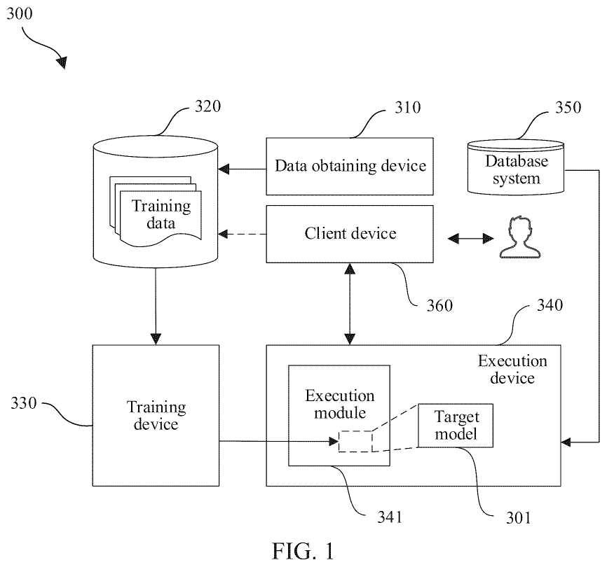

FIG. 1 is a schematic diagram of an example system architecture. A text generation method may be applied to a system 300 shown in FIG. 1. As shown in FIG. 1, a data obtaining device 310 may be configured to obtain training data. For the text generation method, the training data may include each interactive text pair in an interactive content library configured for model training. The data obtaining device 310 may store the training data into a database 320 after obtaining the training data. A training device 330 may perform training, based on the training data maintained in the database 320, to obtain a target model 301.

Specifically, the training device 330 may train a preset neural network based on input training data until the preset neural network satisfies a preset condition, to obtain a trained target model 301. The preset condition may be, for example: a total loss value of a target loss function being less than a preset value, the total loss value of the target loss function not changing any more, a number of trainings reaching a preset number, and an output result of the preset neural network satisfying an output condition, for example, score calculation performed on the output result to determine whether the preset neural network can output an ideal result. In one or more examples, the target model 301 can be configured to implement the text generation method.

The target model 301 may be, in some examples, a deep neural network model, for example, a convolutional neural network. In some arrangements, the training data maintained in the database 320 might not necessarily come from the data obtaining device 310, and may be received from other devices. For example, a client device 360 may alternatively serve as a data obtaining end and store obtained data into the database 320 as new training data. In addition, the training device 330 might not train the preset neural network completely based on the training data maintained by the database 320; instead, the training device 330 may train the preset neural network based on the training data obtained from a cloud or another device. The foregoing descriptions are merely examples and are not limiting.

The target model 301 trained by the foregoing training device 330 may be applied to different systems or devices, for example, applied to an execution device 340 shown in FIG. 1. The execution device 340 may be a terminal, for example, a mobile phone terminal, a tablet computer, a notebook computer, augmented reality (AR)/virtual reality (VR), or may be a server or a cloud, but is not limited thereto.

In FIG. 1, the execution device 340 may be configured to perform data interactive with an external device. For example, the client device 360 may transmit input data to the execution device 340 through a network. In one or more arrangements, the input data may include: text input transmitted by the client device 360. In a related processing process such as preprocessing the text input by the execution device 340 or performing calculation by an execution module 341 of the execution device 340, the execution device 340 may invoke data, a program (e.g., computer readable instructions or code), and the like in a data storage system 350 for calculation processing, and store data and instructions, such as a processing result obtained through the calculation processing, into the data storage system 350.

Finally, the execution device 340 may return the processing result, that is, target text generated based on the target model 301, to the client device 360 through a network, so that a user can query the processing result on the client device 360. The training device 330 may generate, based on different training data, corresponding target models 301 for different targets or different tasks. The corresponding target model 301 may be configured for achieving the foregoing targets or completing the foregoing tasks, so as to provide required results for the user.

For example, the system 300 shown in FIG. 1 may be Client-Server (C/S) system architecture. The execution device 340 may be a cloud server deployed by a service provider. The client device 360 may be a notebook computer used by a game player. For example, when the game player plays a game on a game client of the notebook computer, the game client transmits text input that needs to be subjected to interactive content enriching to the cloud server. When the cloud server receives the text input, interactive content enriching is performed on the text input by using the target model 301 to generate target text, and the target text is returned to the notebook computer. Then, the game client may broadcast related game interactive content to the game player based on the target text.

FIG. 1 is only an example schematic architectural diagram of an example system. The architecture and application scenario of the system described herein are intended to describe the technical solutions in one arrangement, and is not limiting. For example, the data storage system 350 in FIG. 1 is described as an external memory relative to the execution device 340. However, in other cases, the data storage system 350 may alternatively be disposed in the execution device 340. The execution device 340 may alternatively be directly a client device. The application scenario may alternatively be a scenario of a medical robot customer service. Those of ordinary skill may learn that, with evolution of system architecture and appearance of a new application scenario, aspects described herein may also be applicable to solving a similar technical problem.

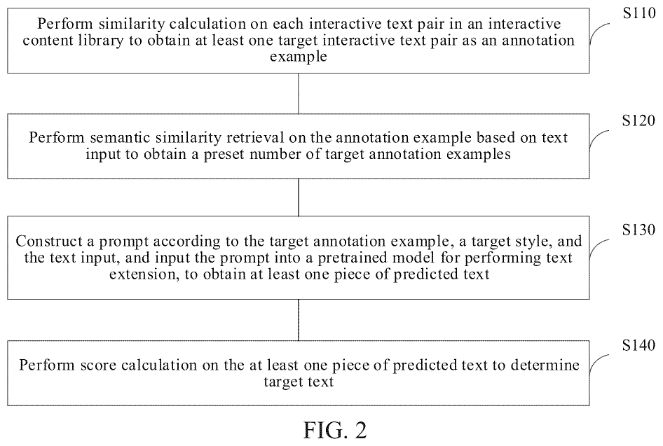

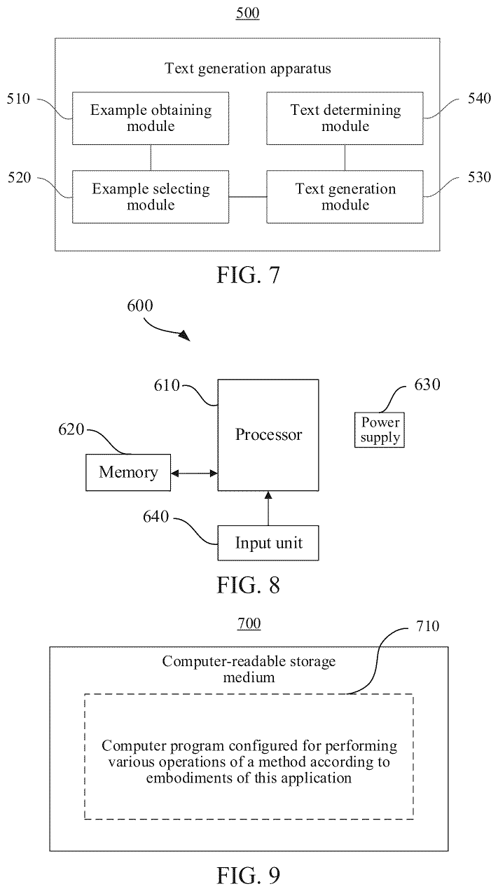

FIG. 2 is a schematic flowchart of an example text generation method. In one or more arrangements, the text generation method may be applied to a text generation apparatus 500 shown in FIG. 7 and a computer device 600 (FIG. 8) provided with the text generation apparatus 500.

An example process is described below by taking a computer device as an example. The computer device may be a server, a terminal, or the like. The server may be an independent physical server, may alternatively be a server cluster or a distributed system composed of a plurality of physical servers, or may alternatively be a cloud server providing basic cloud computing services, such as a cloud service, a cloud database, cloud computing, a cloud function, cloud storage, a network service, cloud communication, a middleware service, a domain name service, a security service, a content delivery network (CDN), blockchain, big data, and an artificial intelligence platform. The terminal may be a smartphone, a tablet computer, a notebook computer, a desktop computer, a smart speaker, a smart watch, and the like, but is not limited thereto. The text generation method may include the following operations:

Operation S110: Perform similarity calculation on each interactive text pair in an interactive content library to obtain at least one target interactive text pair as an annotation example. The annotation example has a corresponding transformation style, and the corresponding transformation style is a transformation style between two pieces of interactive text in each target interactive text pair in the annotation example.

Considering a potential lack of corpus data and high dependency of a text paraphrasing task on a training corpus in a related art, aspects described herein creatively provide a method for guiding a pretrained model to generate interactive content related to a specific field in a case of a small number of examples in a manner of constructing a prompt through a small number of examples in combination with a target style. The example is an in-context example. The prompt in this example is a short text fragment or a text template, and is configured for guiding a model to generate a specific type of output. The specific type of output may be in a form such as a problem, instructions, or an example, and provide context and a direction for a model. Through the skillfully designed prompt, the model may be guided to generate a more accurate and targeted answer and creative output. According to one or more aspects, an experiment of text style transformation only is first performed by constructing a zero-shot type of prompt, and an experiment result cannot achieve an expected effect. Therefore, the prompt is constructed based on a multi-style example in a few-shot type to achieve a transfer task experiment of any style, and a style type of the example is not strictly limited in the experiment.

Specifically, five examples are written manually to guide the pretrained model to generate content satisfying an expectation. A specific example is as follows:

```
  There is such text, {the enemy's health point is low, let's recover before looking for an
opportunity to attack.}, and this sentence is rewritten to make this sentence more simplified.
{Health points are low, let's recover before proceeding}
  ###
  There is such text, {the enemy's health point is low, let's recover before looking for an
opportunity to attack.}, and this sentence is rewritten to make this sentence more simplified.
{Health points are low, let's recover before proceeding.}
  ###
  There is such text, {a vehicle is approaching from the northeast, and is fully staffed.}, and
this sentence is rewritten to make this sentence richer. {oops, danger alarm, a fully staffed vehicle
is coming from the northeast. Special forces, keep low}
  ###
  There is such text, {One step away from victory, don't be discouraged, practice more
marksmanship, and you will be a winner next time.} and this sentence is rewritten to make this
sentence contain more sad emotions. {Hey, so sad, you are almost winning, you have to practice
more marksmanship}
  ###
  There is such text, {It's getting cold, keep warm.}, and this sentence is rewritten to make this
sentence more like Xiaoji. {qiu! It's getting cold recently, Xiaoji seems to be about to catch a
cold, you also need to keep warm.}
  ###
```

Further, the five examples written above form a complete prompt in combination with text input, and the prompt is inputted into a pretrained model to generate a corresponding prediction result, that is, new interactive content. The prediction result above reflects two problems: the new interactive content lacks diversity and the generated interactive content has low quality. It is found by analyzing the prediction result that: the diversity of the interactive content and quality of the interactive content may be affected by an example and a target style in the prompt.

Since selection of an example in the prompt affects generation of the new interactive content by the pretrained model, an interactive text pair having a relatively high similarity and a specific transformation style may be selected from the interactive content library as an annotation example to construct an example library, so as to improve quality of the prompt. The annotation example may have a corresponding transformation style, and the transformation style may be taken as an annotation and may be manually annotated.

The interactive content library may be a text library that stores similar interactive text pairs manually extracted from policy points of multi-interactive text (interactive content). For example, game policy interactive text pair stored in a broadcast content library (Gbot Data) of a game product may be manually extracted. Aspects described herein provide for selecting interactive text pairs with a relatively high similarity and a specific transformation style from the interactive content library as an annotation example to construct an example library.

In some examples, the performing similarity calculation on each interactive text pair in an interactive content library to obtain at least one target interactive text pair as an annotation example may include:
(1) First semantic encoding is performed on each interactive text pair in the interactive content library to obtain an interactive text vector of each interactive text pair.

In one example, the interactive text vector (for example, a sentence vector) of each interactive text pair may be obtained by performing first semantic encoding on each interactive text pair in the interactive content library, for example, (vectorizing). Then, an annotation example satisfying a condition may be selected by calculating a similarity by using the interactive text vector. For example, each interactive text pair in the interactive content library may be encoded by using a USEM encoder.
(2) A first semantic similarity of each interactive text pair is calculated based on the interactive text vector. The first semantic similarity of each interactive text pair is the first semantic similarity between two pieces of interactive text in each interactive text pair.

In one example, when the interactive text vector of each interactive text pair is obtained, the first semantic similarity of each interactive text pair may be calculated according to the interactive text vector of each interactive text pair. For example, a cosine similarity between interactive text α and interactive text β in the interactive text pair may be calculated. Then, the obtained cosine similarity may be taken as the first semantic similarity between the interactive text α and interactive text β in the interactive text pair.
(3) At least one target interactive text pair with the first semantic similarity within a first threshold range is taken as the annotation example.

The first threshold range may be a condition basis for determining whether two pieces of interactive text in each interactive text pair can be taken as the annotation example. The first threshold range may be a preset value range, for example, greater than 0.71. The interactive text pair with the first semantic similarity greater than 0.71 may be taken as the annotation example.

In one example, the first semantic similarity of each interactive text pair may be compared with the first threshold range after the first semantic similarity of each interactive text pair is obtained. For example, the first semantic similarity between interactive text α and interactive text β in an interactive text pair A is 0.83 and is greater than 0.71, so the interactive text pair A (that is, a target interactive text pair) may be taken as the annotation example.

According to one or more arrangements, when the annotation example is determined, the annotation example may be manually annotated, so as to determine a transformation style to which the annotation example belongs. For example, for interactive text text_a=“What a pity! Another round, special forces” and interactive text text_b=“What a shame˜Make persistent efforts, special forces!” in the annotation example, manually annotate an annotation style=“statement transformation”. Thus, the similarity calculation is performed on each interactive text pair in the interactive content library to obtain at least one target interactive text pair as an annotation example, so that the example library is constructed based on at least one annotation example.

Operation S120: Perform semantic similarity retrieval on the annotation example based on text input to obtain a preset number of target annotation examples.

Selection of the example may directly affect quality of constructing the prompt, and then further may affect quality of interactive content generated by a model. Considering that an application scenario is established in a scenario with little or no annotation data, how to enrich interactive content by less manual selection of examples may need to be solved. Therefore, aspects described herein provide that the prompt may be constructed by selecting examples with higher quality from an example library, so that the model can better use and play contained knowledge about interactive content transformation, thereby improving quality of interactive content transformation (generation).

The text input may be a piece of text that needs to be subjected to interactive content enrichment. By mapping the text input and each annotation example to the same vector space and based on similarity calculation, an annotation example that is more semantically similar to that of the text input may be retrieved and taken as a high-quality target annotation example.

In some examples, the performing semantic similarity retrieval on the annotation example based on text input to obtain a preset number of target annotation examples may include:
(1) the text input and each annotation example are encoded into target vector space to obtain a text vector corresponding to the text input and an annotation example vector corresponding to each annotation example.

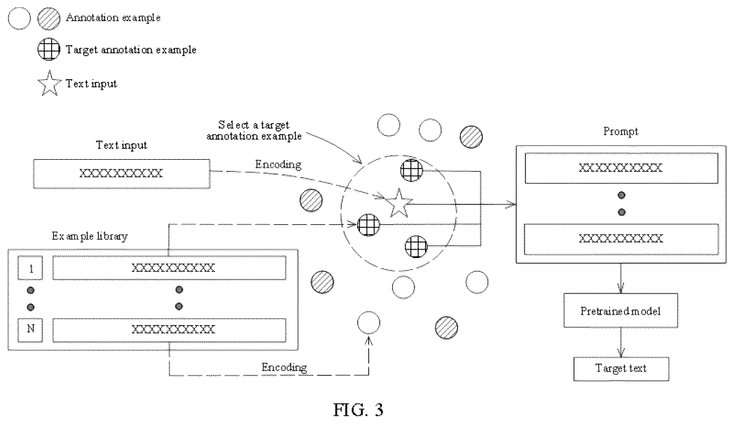

The target vector space may refer to the text input and each annotation example being mapped to the same low-dimension vector space after being encoded. FIG. 3 is a schematic diagram of an example process for selecting a target annotation. As shown in FIG. 3, the text input and each annotation example in the example library may be respectively encoded into the target vector space by using an encoder, and semantic similarity retrieval may be performed.
(2) Semantic similarity retrieval is performed on each annotation example vector based on the text vector to obtain a preset number of target annotation examples.

When the text input and each annotation example in the example library are encoded into the target vector space, semantic similarity retrieval may be performed, based on the text vector corresponding to the text input, on the annotation example vector corresponding to each annotation example to obtain an annotation example that is more semantically similar to the text input, and the annotation example may be taken as a target annotation example. In this case, the target annotation example carries more information associated with the text input, so that text having a stronger association with the text input may be generated when a few-shot type transfer task is executed (for example, text extension), thereby improving quality of interactive content generation.

In one example, semantic similarity retrieval may be performed on each annotation example vector based on the text vector to obtain a second semantic similarity between the text vector and each annotation example vector, and the annotation examples corresponding to each annotation example vector may be sorted in descending order according to the second semantic similarity to obtain an example rank. Further, a preset number of intermediate examples may be selected from the example rank based on the descending order, and an example in the intermediate examples with the second semantic similarity within a second threshold range may be taken as the target annotation example.

The second threshold range may be a condition basis for determining whether each annotation example can be taken as the target annotation example. The second threshold range may be a preset value range, for example, greater than 0.6. The preset number may be a preset number K of annotation examples closest to (neighboring to) a location of the text input in the target vector space, for example, K may be 30.

There may be a case where an example number of the annotation examples with the second semantic similarity within the second threshold range is less than the preset number K. Therefore, when the example number is less than the preset number K, examples may be randomly selected from handcrafted examples for complementing the annotation examples.

In some examples, an example number of the target annotation examples may be obtained. Further, when the example number of the target annotation examples is less than the preset number, an example complementing operation may be executed. Specifically, the annotation examples may be randomly selected from handcrafted examples to complement the target annotation examples until the example number of the target annotation examples is equal to the preset number.

Considering that two pieces of interactive text in some target annotation examples may have meanings similar to each other, if the two pieces of interactive text are configured for constructing a prompt, a difference in interactive content generation will be affected, and generated interactive content might not be diversified. Therefore, diversity of interactive content enrichment may be improved by limiting a piece of interactive text in the target annotation examples belonging to the same standard problem.

In some examples, standard problem detection may be performed on each target annotation example to determine a target annotation example corresponding to the standard problem. The standard problem is configured for representing an interactive content policy point corresponding to the target annotation example. According to one or more aspects, each piece of interactive text in the interactive content library may be answers to different problems (policy point). These different problems may form a plurality of problem clusters, and each problem cluster include similar problems. Each problem cluster may correspond to a standard problem. This standard problem may be specified from the similar problems in the problem cluster. Corresponding, each piece of interactive text will correspond to a standard problem. Further, mutual information of the target annotation examples corresponding to the same standard problem may be calculated to obtain the mutual information of two pieces of interactive text in the target annotation examples corresponding to the same standard problem. The mutual information may refer to a measure of mutual dependency between two random variables, and may be configured for quantizing useful information. According to one or more arrangements, interactive text that is more semantically consistent with the standard problem may be determined after calculating the mutual information of the two pieces of interactive text in the target annotation examples with the same standard problem.

Further, values of the mutual information of the two pieces of interactive text may be compared, and interactive text corresponding to the mutual information having a smaller value may be deleted from the two pieces of interactive text. For example, if the mutual information of interactive text text_a in the target annotation example is less than the mutual information of interactive text text_b, the interactive text text_a may be deleted from the target annotation example, so that interactive content is prevented from being excessively close, and diversity of interactive content enrichment is increased.

Operation S130: Construct a prompt according to the target annotation example, a target style, and the text input, and input the prompt into a pretrained model for performing text extension, to obtain at least one piece of predicted text. The target style is a style into which the text input is to be transformed.

According to aspects described herein, the pretrained model may effectively capture knowledge from a small amount of annotated or unannotated data to extend a model generalization capability, and provide a manner of constructing the prompt by combining a small number of examples and transform styles to guide the pretrained model to perform related interactive content enrichment (generation) in a specific field (a game, a virtual customer service, or the like).

The pretrained model may be, for example, a transfer learning application, which may represent context of each member (a character or a word) in text in a related manner, and complete learning of syntactic and semantic knowledge in an implicit manner. Each time the pretrained model is extended to a new scenario, interactive content enrichment may be rapidly performed in this scenario by only performing targeted learning on a specific annotation example in this scenario.

The prompt, as input information for guiding the pretrained model to perform related interactive content enrichment in a specific field, may include a text input, a target annotation example, and a target style.

For example, each target annotation example may be represented by using the same template: “here is such text, {example.text_a}, this sentence is rewritten to make this sentence {example.style}. {example.text_b}”. “example.text_a” indicates text that needs to be transformed in the target annotation example, “example.style” indicates a style into which example.text_a needs to be transformed, and “example.text_b” indicates text generated by transformation according to the “example.style”. For example, there is such text, {a vehicle is approaching from the northeast and is fully staffed. (that is, example.text_a)}, and this sentence is rewritten to make this sentence richer (that is, example.style). {oops, danger alarm, a fully staffed vehicle comes from the northeast. Special forces, keep low (that is, example.text_b)}.

Based on a template of the target annotation example, a template related to the text input may be obtained by combining the text input and the target style: “there is such text, {Text Input}, this sentence may be rewritten to make this sentence become {Target Style}. {“,” {“at the end of the template is configured for instructing the pretrained model to output predicted text corresponding to text input.

Further, the prompt constructed by the target annotation example, the target style, and the text input may be input into the pretrained model for performing text extension to obtain at least one piece of predicted text. Different types of pretrained models may be selected according to an actual application scenario. This is not limited herein. For example, Transformer-XL may be selected as a pretrained model. Accordingly, in this example, a prompt is input into the Transformer-XL, where the prompt is as follows:

```
  There is such text, {XXXXX₁(example.text_a)}, and this sentence is rewritten to make this
sentence richer (that is, example.style). {YYYYY₁(example.text_b)}
  ###
  There is such text, {XXXXX₂(example.text_a)}, and this sentence is rewritten to make this
sentence more simplified (that is, example.style). {YYYYY₂(example.text_b)}
  ###
  There is such text, {XXXXX₃(example.text_a)}, and this sentence is rewritten to transform a
statement of this sentence (example.style). {YYYYY₃(example.text_b)}
  ###
  There is such text, {there are quite a few enemies, it's not suitable for direct confrontation},
and this sentence is rewritten to transform a statement of this sentence. {
  There is such text, {there are quite a few enemies, it's not suitable for direct confrontation},
and this sentence is rewritten to make this sentence more simplified. {
  There is such text, {there are quite a few enemies, it's not suitable for direct confrontation},
and this sentence is rewritten to make this sentence richer. {
```

Further, the Transformer-XL may perform text extension according to the input prompt, and output a prediction result:

{there is a large number of enemies, let's avoid confrontation and find an opportunity to battle again}

{there are many enemies, let's play slowly and steadily}

{there are quite a few enemies, it's too disadvantageous to fight, we need to use a strategy}

Operation S140: Perform score calculation on the at least one piece of predicted text to determine target text.

At least one piece of predicted text may be obtained after the pretrained model performs text extension. To ensure that the generated interactive content of different expressions is obtained based on the same semantics, and to reduce deviation degree between semantics of the newly generated interactive content and semantics of original interactive content, aspects described herein provide that score calculation may be performed on the predicted text by using different evaluation standards to determine the target text, so as to select new interactive content with relatively high quality.

The evaluation standards may include a text similarity determined by a semantic similarity and a content similarity, which may be configured for evaluating that the newly generated interactive content retains semantic information of the original interactive content. The evaluation standards may include style confidence, which may be configured for determining a confidence that the newly generated interactive content is a specified style. Further, smoothness may alternatively be set for filtering out incorrectly generated extreme text.

In one or more examples, performing score calculation on the at least one piece of predicted text to determine target text may include:
(1) A text similarity between each piece of predicted text and the text input is obtained based the text input and second semantic encoding of each piece of predicted text.

In one example, second semantic encoding may be performed on the at least one piece of predicted text to obtain a predicted text vector corresponding to each piece of predicted text. Second semantic encoding may be performed on the text input to obtain a text input vector corresponding to the text input. A manner of the second semantic encoding may be the same as or different from a manner of the first semantic encoding.

Further, a semantic similarity between each piece of predicted text and the text input may be calculated based on the predicted text vector and the text input vector. A content similarity between each piece of predicted text and the text input may be calculated based on the predicted text vector and the text input vector. Then, the text similarity between each piece of predicted text and the text input may be determined according to the semantic similarity and the content similarity. Thus, by taking the text similarity as an evaluation standard, new interactive content that does not semantically deviate from the original interactive content may be screened, and generated interactive content may be prevented from semantically deviating from the original interactive content.
(2) Style prediction is performed on each piece of predicted text based on a language model to obtain style confidence of each piece of predicted text.

In some examples, style prediction may be performed on each piece of predicted text by using a language model, for example, a masked language model, to obtain the style confidence of each piece of predicted text. Thus, whether the style of the newly generated interactive content satisfies an expected target style may be determined according to the style confidence, thereby improving controllability or designability of the interactive content enrichment.

It is considered that interactive content enrichment may need to satisfy specific expression requirements in different application scenarios. For example, sometimes transformation styles of the interactive content may need to be diversified, so semantic deviation is tolerated. In other examples, sometimes transformation styles of the interactive content need to be simplified, so a semantic deviation tolerance is relatively low. Therefore, different weights may be set for the text similarity and the style confidence to select specified target text according to a specific application requirement.
(3) Target text is determined from the at least one piece of predicted text according to the text similarity and the style confidence.

In one or more examples, weighted summation may be performed on a product of a first weight and the text similarity and a product of a second weight and the style confidence to obtain a selection score, and the at least one piece of predicted text may be sorted in descending order according to the selection score to obtain a predicted text rank. Further, the target text may be determined from the predicted text rank based on the descending order.

According to one or more aspects, the similarity calculation may be performed on each interactive text pair in an interactive content library to obtain at least one target interactive text pair as an annotation example, an example library may be constructed to complete interactive content enrichment based on a small amount of data, and semantic similarity retrieval may be performed on each annotation example based on the text input to obtain a preset number of target annotation examples. Therefore, a high-quality example with more information may be selected from the example library, so that the pretrained model can better use and/or play knowledge about interactive content transformation.

Further, prompts may be constructed according to the target annotation example, the target style, and the text input, and a prompt may be input into the pretrained model for performing text extension to obtain at least one piece of predicted text. Additionally, score calculation may be performed on the at least one piece of predicted text to determine the target text. Thus, high-quality target annotation examples and different target styles may be selected to guide the pretrained model to generate diversified interactive content, interactive content in a specified style may be generated in a targeted manner based on the target annotation example with a standardized template and a specified target style, and enriched (generated) interactive content may be ensured not to semantically deviate from the original interactive content by performing score calculation on the predicted text, thereby improving quality of interactive content enrichment.

In combination with the methods described herein, the following further describes further details using an example.

The text generation methods described herein involve an artificial intelligence (AI) technology. The AI technology involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI may include the study of the design principles and implementation methods of various intelligent machines, to enable the machines to have the functions of perception, reasoning, and decision-making.

AI technology is a comprehensive discipline, and relates to a wide range of fields including both hardware-level technologies and software-level technologies. The basic AI technologies may generally include technologies such as a sensor, a dedicated AI chip, cloud computing, distributed storage, a big data processing technology, an operating/interactive system, and electromechanical integration. AI software technologies may mainly include several major directions such as a computer vision (CV) technology, a speech processing technology, a nature language processing technology, and machine learning/deep learning.

Nature language processing (NLP) is an important direction in the field of computer science and artificial intelligence. It studies various theories and methods that can realize efficient communication between humans and computers by using a natural language. The NLP is a science that integrates linguistics, computer science, and mathematics. Therefore, the study in this field will involve natural language, that is, the language used by people in daily life, so it is closely related to the study of linguistics. The NLP technology usually includes technologies, such as text processing, semantic understanding, machine translation, robot question answering, and knowledge mapping.

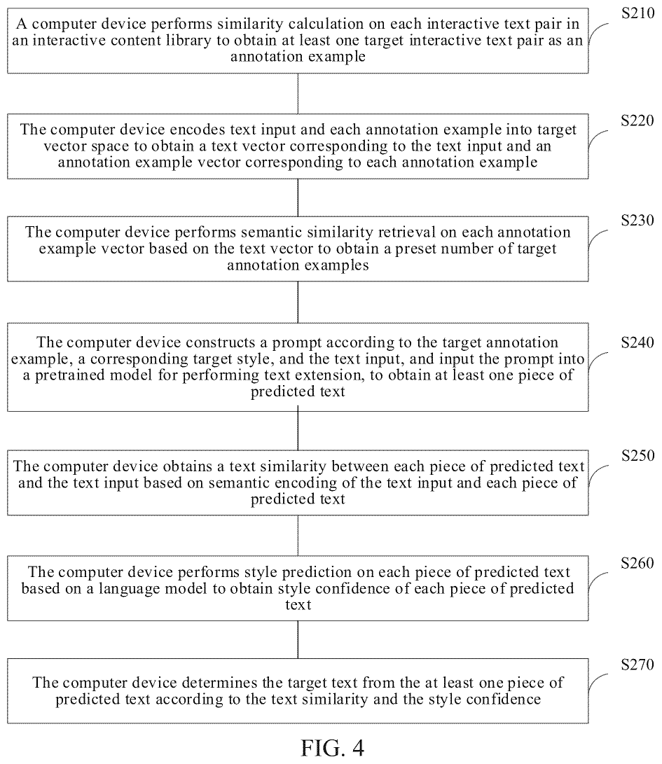

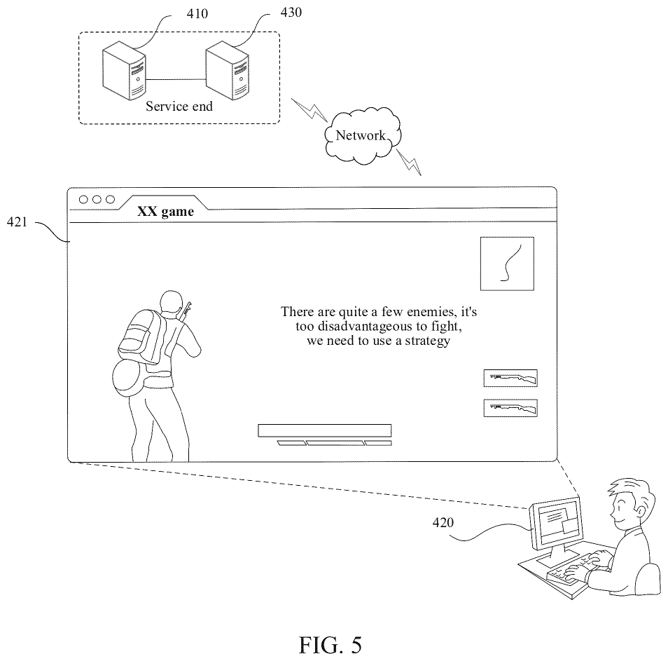

The text generation method relate to and involve technologies such as natural language processing of artificial intelligence. Descriptions are provided below by using an example in which a text generation apparatus is integrated into or otherwise included as part of a computer device, and a process shown in FIG. 4 is described in detail with reference to an application scenario shown in FIG. 5. The computer device may be a server, a terminal device, or the like. FIG. 4 is another text generation method. In one or more arrangements, the text generation method may be applied to a game scenario shown in FIG. 5.

A game service provider may provide a server end. The server end may include a cloud training server 410 and a cloud execution server 430. The cloud training server 410 may be configured to train a text extension model for performing interactive content enrichment. The cloud execution server 430 may be configured to deploy the text extension model obtained through training by the cloud training server 410, and perform text extension on text input transmitted by a client to obtain target text. The client may be game software 421 opened (e.g., installed and/or executed) on a computer 420 by a game player.

FIG. 5 is only an example application scenario. The application scenario described with respect to FIG. 5 is not limiting. Those of ordinary skill may learn that, with evolution of system architecture and appearance of a new application scenario (such as virtual human customer service and virtual human broadcast), the technical solution described herein may be applicable to solving a similar technical problem.

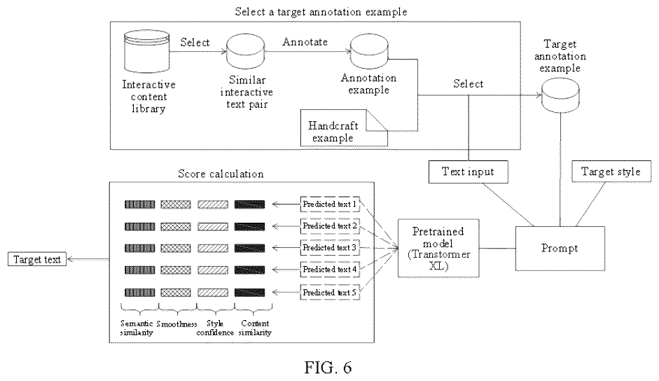

For example, FIG. 6 is a schematic diagram of an example framework of interactive content enrichment. To better understand this solution, the following is understood together with reference to FIG. 6. The text generation method in FIG. 4 may include the following operations:

Operation S210: A computer device performs similarity calculation on each interactive text pair in an interactive content library to obtain at least one target interactive text pair as an annotation example. The annotation example has a corresponding transformation style, and the corresponding transformation style is a transformation style between two pieces of interactive text in each target interactive text pair in the annotation example.

Since there is often a potential lack of corpus data and high dependence of a text paraphrasing task on a training corpus in a related art, aspects described herein provide a method for guiding a pretrained model to generate interactive content related to a specific field in a case of a small number of examples in a manner of constructing a prompt through a small number of examples in combination with a transformation style.

In some examples, the performing, by a computer device, similarity calculation on each interactive text pair in an interactive content library to obtain at least one target interactive text pair as an annotation example may include:
(1) the computer device performs semantic encoding on each interactive text pair in the interactive content library to obtain an interactive text vector of each interactive text pair.

For example, when a game of a player enters a decision-making scenario, the game software 421 prepares to broadcast game decision-making interactive content for the player in voice. The game software 421 may transmit the interactive content “there are many enemies, it's not suitable for direct confrontation” related to the decision-making scenario/policy point to the cloud execution server 430.

Further, the cloud execution server 430 may perform semantic encoding on each similar interactive text pair in the interactive content library associated with the game based on an USEM encoder, to obtain an interactive text vector of each similar interactive text pair. Then, an annotation example may be selected by calculating a similarity by using the interactive text vector.
(2) The computer device calculates a first semantic similarity of each interactive text pair based on the interactive text vector. The first semantic similarity of each interactive text pair is the first semantic similarity between two pieces of interactive text in each interactive text pair.

For example, when obtaining the interactive text vector of each similar interactive text pair, the cloud execution server 430 may calculate a cosine similarity distance between two pieces of interactive text in each interactive text pair according to the interactive text vector of each similar interactive text pair, and take the cosine similarity as the first semantic similarity.
(3) The computer device takes at least one target interactive text pair with the first semantic similarity within a first threshold range as the annotation example.

For example, the cloud execution server 430 may compare the first semantic similarity of each similar interactive text pair with the first threshold range. For example, the first semantic similarity between interactive text α and interactive text β in a similar interactive text pair A is 0.83 and is greater than 0.71, so the similar interactive text pair A, that is, a target interactive text pair may be taken as the annotation example.

When the annotation example is determined, the annotation example may be manually annotated, so as to determine a transformation style that the annotation example belongs. In a game application scenario according to the embodiments of this application, six types of transformation styles may be annotated, including:
(1) statement transformation: text_a and text_b are synonymous descriptions;
(2) emotion enrichment: there is an emotion change from text_a to text_b;
(3) content enrichment: text_b includes all content of text_a, and information is added on this basis;
(4) content simplification: text_b retains backbone information of text_a, and information that does not affect an overall meaning is deleted;
(5) special forces style: text_b transforms a subject into a special force only based on text_a; and
(6) auxiliary personalization: more auxiliary character features are increased in text_b compared with text_a.

Further, for example, 174 pairs of annotation examples may be obtained. Each annotation example includes two pieces of interactive text (text_a and text_b). A format may be shown as follows:

| text_a | text_b | style |
|---|---|---|
| What a pity! Another round, | What a shame~Make | Statement |
| special forces | persistent efforts, | transformation |
| | special forces! | |
| In addition to oil filling, an | Shoot the oil barrel | Content |
| oil barrel can further be | continuously to | simplification |
| detonated by shooting! | detonate it | |
| Xiaoji also likes himself | What! Xiaoji also | Emotion |
| | loves himself | enrichment |

In a scenario with a small amount of annotation data or without annotation data, selection of examples affects quality of constructing a prompt, and then affects quality of interactive content generated by a model. Aspects described herein provide that the prompt may be constructed by selecting examples with higher quality from an example library, so that the model can better use and/or play contained knowledge about interactive content transformation, thereby improving quality of interactive content transformation.

Operation S220: The computer device encodes the text input and each annotation example into target vector space to obtain a text vector corresponding to the text input and an annotation example vector corresponding to each annotation example.

The text input may be a piece of text that needs to be subjected to interactive content enrichment. By mapping the text input and each annotation example to the same vector space and through similarity calculation, an annotation example that is more semantically similar to that of the text input may be retrieved and taken as a high-quality target annotation example.

For example, the cloud execution server 430 may encode the text input and each annotation example in the example library in a same manner by using an encoder, to obtain the text vector corresponding to the text input and the annotation example vector corresponding to each annotation example, so that the text input and each annotation example are encoded into the target vector space.

Operation S230: The computer device performs semantic similarity retrieval on each annotation example vector based on the text vector to obtain a preset number of target annotation examples.

In some examples, the performing, by the computer device, semantic similarity retrieval on each annotation example vector based on the text vector to obtain a preset number of target annotation examples may include:
(1) The computer device performs semantic similarity retrieval on each annotation example vector based on the text vector to obtain a second semantic similarity between the text vector and each annotation example vector.

For example, the cloud execution server 430 may construct a vector retrieval (such as Faiss, Milvus, and Proxima) index based on the example library by using a USEM encoder, and retrieve closest K annotation examples for the text input. For example, semantic similarity retrieval may be performed on each annotation example vector based on the text vector to obtain a second semantic similarity between the text vector and each annotation example vector.
(2) The computer device sorts the annotation examples corresponding to each annotation example vector in descending order according to the second semantic similarity to obtain an example rank.
(3) The computer device selects a preset number of intermediate examples from the example rank based on the descending order, and takes an example in the intermediate example with the second semantic similarity within a second threshold range as a target annotation example.

For example, the cloud execution server 430 may sort the annotation examples corresponding to each annotation example vector in descending order according to the second semantic similarity to obtain an example rank. Further, a preset number of intermediate examples may be selected from the example rank based on the descending order, and an example in the intermediate examples with the second semantic similarity within a second threshold range may be taken as the target annotation example.

When the closest similarity is within the second threshold range, examples may be randomly selected from handcrafted examples to complement. For example, an example number of the target annotation examples may be obtained. Further, when the example number of the target annotation examples is less than the preset number, an example complementing operation may be executed. The annotation examples may be randomly selected from the handcrafted examples to complement the target annotation examples until the example number of the target annotation examples is equal to the preset number.

For example, the cloud execution server 430 may perform standard problem detection on each target annotation example to determine a target annotation example corresponding to the standard problem. Mutual information calculation may be performed on the target annotation example corresponding to the same standard problem to obtain mutual information of two pieces of interactive text in the target annotation example corresponding to the same standard problem. Values of mutual information of the two pieces of interactive text may be compared, and an interactive text corresponding to mutual information having a smaller value may be deleted from the two pieces of interactive text.

Operation S240: The computer device constructs a prompt according to the target annotation example, a target style, and the text input, and input the prompt into a pretrained model for performing text extension, to obtain at least one piece of predicted text. The target style is a style into which the text input is to be transformed.

For example, each target annotation example is represented by using the same template: “here is such text, {example.text_a}, this sentence is rewritten to make this sentence {example.style}. {example.text_b}”. The target annotation example is combined with the text input and the target style: “there is such text, {text input}, this sentence is rewritten to make this sentence become {target style}. {“constitutes complete a prompt. Further, the cloud execution server 430 may input the prompt into the pretrained model Transformer-XL for performing text extension to obtain five pieces of predicted text. For example, following example prompt may be input into the Transformer-XL:

```
  There is such text, {XXXXX₁}, and this sentence is rewritten to make
this sentence (example.style₁). {YYYYY₁}
  ###
  There is such text, {XXXXX₂}, and this sentence is rewritten to make
this sentence (example.style₂). {YYYYY₂}
  ###
  ...
  There is such text, {XXXXXₙ}, and this sentence is rewritten to make
this sentence (example.styleₘ). {YYYYYₙ}
  ###
  There is such text, {QQQQQ}, and this sentence is rewritten in style₁. {
  There is such text, {QQQQQ}, and this sentence is rewritten in style₂. {
```

“QQQQQ” is text input. Further, the Transformer-XL may perform text extension according to an input prompt, and output a prediction result: QQQQQ′ in style₁, and QQQQQ″ in style₂.

Operation S250: The computer device obtains a text similarity between each piece of predicted text and the text input based on semantic encoding of the text input and each piece of predicted text.

For example, the cloud execution server 430 may perform semantic encoding on the obtained five predicted texts to obtain a predicted text vector corresponding to each piece of predicted text. Semantic encoding may be performed on the text input to obtain a text input vector corresponding to the text input.

Further, the cloud execution server 430 may calculate the semantic similarity between each piece of predicted text and the text input based on the predicted text vector and the text input vector. A content similarity between each piece of predicted text and the text input may be calculated based on the predicted text vector and the text input vector.

For example, the cloud execution server 430 may calculate a cosine similarity between each piece of predicted text and the text input as a semantic similarity. A Bilingual evaluation understudy (BLEU) score between each piece of predicted text and the text input may alternatively be calculated as the content similarity. Then, the text similarity between each piece of predicted text and the text input may be determined according to the semantic similarity and the content similarity.

Operation S260: The computer device performs style prediction on each piece of predicted text based on a language model to obtain style confidence of each piece of predicted text.

For example, the cloud execution server 430 may perform style prediction on each piece of predicted text based on a masked language model to obtain style confidence of each piece of predicted text.

Operation S270: The computer device determines the target text from the at least one piece of predicted text according to the text similarity and the style confidence.

For example, the cloud execution server 430 may perform weighted summation on a product of a first weight and the text similarity and a product of a second weight and the style confidence to obtain a selection score, sort the at least one piece of predicted text in descending order according to the selection score to obtain a predicted text rank, and then determine target text based on the descending order in the predicted text rank.

For example, policy points with only single interactive content may be extracted from the interactive content library as a test set to perform an experiment on an effect of methods described herein. The test set includes 113 policy points in total, and 2104 pieces of interactive content are generated in total. After manual selection and evaluation, effect indicators were obtained as follows:

| | Proportion of at | Average number of |
|---|---|---|
| | least one adoptable | pieces of interactive |
| | interactive content | content adopted at |
| | policy point | each policy point |
| First annotation result | 84.96% | 5.73 |
| Second audit result | 90.27% | 3.17 |

To ensure the rigor of results, the results may be annotated twice. It can be seen that more than 84% of the policy points in the two results can obtain effective extended interactive content through this solution, and in addition, 3.17 pieces of extended interactive content can be obtained for each policy point through this solution on average. In addition, through annotation results, it is found that, one piece of generated interactive content of each policy point may become adoptable interactive content (significance of inspiration) through modification/extension on average.

Part results are shown as follows:

| Original interactive content | Generated interactive content |
|---|---|
| Directly enter a circle to find | Crash into the circle to find someone to fight. |
| someone to battle | |
| Directly enter a circle to find | Ooops, good to find someone to battle fast. |
| someone to battle | |
| Directly enter a circle to find | Directly enter a circle, let's do it to find a person to battle. |
| someone to battle | |
| There are quite a few enemies, it's | There are quite a few enemies, let's play slowly and |
| not suitable for direct confrontation | steadily. |
| There are quite a few enemies, it's | There are quite a few people in this place, let's bypass to |
| not suitable for direct confrontation | avoid troubles. |
| There are quite a few enemies, it's | There are quite a few enemies, it's too disadvantageous to |
| not suitable for direct confrontation | fight, we need to use a strategy |
| There are quite a few enemies, it's | There is a large number of enemies, let's avoid |
| not suitable for direct confrontation | confrontation and find an opportunity to battle again |

It may be learned from the foregoing experimental results that in the methods described herein can complete interactive content enrichment in a case that there is no training data or there is a small amount of training data, and generated interactive content not only can retain content of original interactive content, but can be expressed in diversified manners. Additionally, labor cost can be reduced, and efficiency of constructing the content library can be improved.

In one or more arrangements, similarity calculation may be performed on each interactive text pair in an interactive content library to obtain at least one target interactive text pair as an annotation example, and the text input and each annotation example are encoded into the target vector space to obtain a text vector corresponding to the text input and an annotation example vector corresponding to each annotation example. Further, semantic similarity retrieval may be performed on each annotation example vector based on the text vector to obtain a preset number of target annotation examples. A prompt may be constructed according to the target annotation example, a target style, and the text input, and the prompt may be input into a pretrained model for performing text expansion to obtain at least one piece of predicted text.

Further, semantic encoding may be performed on the text input and each piece of predicted text to obtain a text similarity between each piece of predicted text and the text input, and style prediction may be performed on each piece of predicted text based on a language model to obtain style confidence of each piece of predicted text. Target text may be determined from the at least one piece of predicted text according to the text similarity and the style confidence. Thus, high-quality target annotation examples and different target styles may be selected to guide the pretrained model to generate diversified interactive content, interactive content of a specified style may be generated in a targeted manner based on the target annotation example with a standardized template and a specified target style, and score calculation may be performed on the predicted text, so that the generated interactive content may be prevented from semantically deviating from the original interactive content, thereby effectively improving quality of interactive content enrichment.

Referring to FIG. 7, which is a block diagram of an example text generation apparatus 500. A text generation apparatus 500 may include: an example obtaining module 510, configured to perform similarity calculation on each interactive text pair in an interactive content library to obtain at least one target interactive text pair as an annotation example, the annotation example having a corresponding transformation style, the corresponding transformation style being a transformation style between two pieces of interactive text in each target interactive text pair in the annotation example; an example selecting module 520, configured to perform semantic similarity retrieval in the annotation example based on text input to obtain a preset number of target annotation examples; a text generation module 530, configured to construct a prompt according to the target annotation example, a target style, and the text input, and input the prompt into a pretrained model for performing text extension to obtain at least one piece of predicted text, the target style being a style into which the text input is to be transformed; and a text determining module 540, configured to perform score calculation on the at least one piece of predicted text to determine target text.

In some examples, the example obtaining module 510 may be configured to: perform first semantic encoding on each interactive text pair in the interactive content library to obtain an interactive text vector of each interactive text pair; calculate a first semantic similarity of each interactive text pair based on the interactive text vector, where the first semantic similarity of each interactive text pair is a first semantic similarity between two pieces of interactive text in each interactive text pair; and take at least one target interactive text pair with the first semantic similarity within a first threshold range as an annotation example.

In some arrangements, the example selecting module 520 may include a space transformation unit and a semantic retrieval unit. The space conversion unit may be configured to encode the text input and each annotation example into target vector space to obtain a text vector corresponding to the text input and an annotation example vector corresponding to each annotation example; and the semantic retrieval unit may be configured to perform semantic similarity retrieval on each annotation example vector based on the text vector to obtain a preset number of target annotation examples.

In some arrangements, the semantic retrieval unit may be configured to: perform semantic similarity retrieval on each annotation example vector based on the text vector to obtain a second semantic similarity between the text vector and each annotation example vector; and sort the annotation examples corresponding to each annotation example vector in descending order according to the second semantic similarity to obtain a sample rank; and select a preset number of intermediate examples from the example rank based on the descending order, and take an example in the intermediate examples with the second semantic similarity within a second threshold range as the target annotation example.

In some examples, the semantic retrieval unit may be further configured to: obtain an example number of the target annotation examples; and perform an example completion operation until the example number of the target annotation examples is equal to the preset number when the example number of the target annotation examples is less than the preset number.

According to some aspects, the semantic retrieval unit may be further configured to: perform standard problem detection on each target annotation example to determine a target annotation example corresponding to the standard problem; and perform mutual information calculation on the target annotation example corresponding to the same standard problem to obtain mutual information of two pieces of interactive text in the target annotation example corresponding to the same standard problem; and compare values of the mutual information of the two pieces of interactive text, and delete interactive text corresponding to mutual information having a smaller value from the two pieces of interactive text.

In some arrangements, the text determining module 540 may include a text similarity obtaining unit, a style confidence obtaining unit, and a text determining unit. The text similarity obtaining unit may be configured to obtain a text similarity between each piece of predicted text and the text input based on second semantic encoding of the text input and each piece of predicted text; the style confidence obtaining unit may be configured to perform style prediction on each piece of predicted text based on a language model to obtain style confidence of each piece of predicted text; and the text determining may be configured to determine the target text in the at least one piece of predicted text according to the text similarity and the style confidence.

In some examples, the text similarity obtaining unit may be configured to: perform second semantic encoding on the at least one piece of predicted text to obtain a predicted text vector corresponding to each piece of predicted text; perform second semantic encoding on the text input to obtain a text input vector corresponding to the text input; calculate a semantic similarity between each piece of predicted text and the text input based on the predicted text vector and the text input vector; calculate a content similarity between each piece of predicted text and the text input based on the predicted text vector and the text input vector; and determine a text similarity between each piece of predicted text and the text input according on the semantic similarity and the content similarity.

In some arrangements, the text determining unit may be configured to: perform weighted summation on a product of a first weight and the text similarity and a product of a second weight and the style confidence to obtain a selection score; sort the at least one piece of predicted text in descending order according to the selection score to obtain a predicted text rank; and determine the target text from the predicted text rank based on the descending order.

Those skilled in the art can clearly understand that for convenience and conciseness of description, for specific working processes of the apparatus and modules described above, refer to corresponding processes in the foregoing methods. Details are not described herein again.

In various arrangements, mutual coupling between modules may be electrical coupling, mechanical coupling, or other forms of coupling.

In addition, various functional modules may be integrated into one processing module, or various modules may exist physically independently, or two or more modules may be integrated into one module. The integrated module described above may be implemented in a form of hardware, or may be implemented in a form of a software functional module.

According to aspects described herein, similarity calculation may be performed on each interactive text pair in an interactive content library to obtain at least one target interactive text pair as an annotation example; the annotation example has a corresponding transformation style; semantic similarity retrieval is performed on the annotation example based on text input to obtain a preset number of target annotation examples; a prompt is constructed according to the target annotation example, a target style, and the text input, and the prompt is input into a pretrained model for performing text extension to obtain at least one piece of predicted text; and then, score calculation is performed on the at least one piece of predicted text to determine target text. Thus, high-quality target annotation examples and different target styles are selected to guide the pretrained model to generate diversified interactive content, interactive content in a specified style may be generated in a targeted manner based on the target annotation example with a standardized template and a specified target style, and interactive content is ensured not to semantically deviate from the original interactive content by performing score calculation on the predicted text, thereby effectively improving quality of interactive content enrichment.

FIG. 8 illustrates an example computer device 600. The computer device 600 includes a processor 610, a memory 620, a power supply 630, and an input unit 640. The memory 620 stores a computer program. The computer program may perform various operations of the methods described herein when invoked by the processor 610. Those skill in the art can understand that a structure of the computer device shown in the figure does not constitute a limit on the computer device, and may include components that are more or fewer than those shown in the figure, or a combination of some components, or different component arrangements.

The processor 610 may include one or more processing cores. The processor 610 connects various parts in an overall battery management system by using various interfaces and lines, and performs various functions of the battery management system and processes data, and performs various functions of the computer device and processes data by running or executing instructions, a program, an instruction set, or a program set stored in the memory 620 and invoking data stored in the memory 620, thereby controlling the overall computer device. The processor 610 may be implemented in at least one hardware form of a digital signal processor (DSP), a field-programmable gate array (FPGA), and a programmable logic array (PLA). The processor 610 may integrate one or a combination of several of a central processing unit (CPU) 610, a graphics processing unit (GPU) 610, a modem, and the like. The CPU may primarily process (e.g., execute) an operating system, a user interface, an application program, and the like. The GPU may be responsible for rendering and drawing display content. The modem may be configured to process wireless communication. The foregoing modem might not be integrated into the processor 610, and is separately implemented through a communication chip.

The memory 620 may include a random access memory (RAM) 620, and may alternatively include a read-only memory 620. The memory 620 may be configured to store the instructions, the program, the instruction set, or the program set. The memory 620 may include a program storage area and a data storage area. The program storage area may store instructions configured for implementing the operating system, instructions configured for realizing at least one function (for example, a touch control function, a sound playing function, and an image playing function), instructions configured for implementing various method embodiments above, and the like. The data storage area may store data (for example, a phone book and audio and video data) created by the computer device during use. Correspondingly, the memory 620 may further include a memory controller to provide access of the processor 610 to the memory 620.

The power supply 630 may be logically connected to the processor 610 by using a power supply management system to implement functions of managing charge, discharge, power consumption, and the like by using the power supply management system. The power supply 630 may further include one or more of a direct current or alternating current power supply, a re-charging system, a power failure detection circuit, a power supply converter or inverter, a power supply state indicator, and any other components.

The input unit 640 may be configured to receive input numeric or character information and generate keyboard, mouse, joystick, optical, or trackball signal input related to user settings and function control.

Although not shown in the figure, the computer device 600 may further include a display unit and the like. Details are not described herein again. For example, the processor 610 in the computer device may load, according to the following instructions, executable files corresponding to processes of one or more computer programs into the memory 620. The processor 610 may run (e.g., execute), for example, the phone book and the audio and video data, stored in the memory 620, thereby implementing various operations of the methods described herein.

As shown in FIG. 9, aspects described herein further provide a computer-readable storage medium 700. The computer-readable storage medium 700 stores a computer program 710. The computer program 710 is invokable by a processor to perform various operations of the methods described herein.

The computer-readable storage may be electronic memories such as an electrically erasable programmable read-only memory (EEPROM), an erasable programmable read-only memory (EPROM), a hard disk, or a read-only memory (ROM). The computer-readable storage medium includes a non-transitory computer-readable storage medium. The computer-readable storage medium 700 has storage space for computer programs for performing operations in any methods described herein. These computer programs may be read from one or more computer program products or written into the one or more computer program products. The computer programs can be compressed in proper forms.

According to one or more aspects, a computer program product may be provided. The computer program product may include a computer program. The computer program may be stored in the computer-readable storage medium. A processor of a computer device may read the computer program from the computer-readable storage medium, and the processor may execute the computer program, so that the computer device performs various operations of the methods described herein.

The above descriptions are merely some aspects, and are not intended to be limiting. Any person skilled in the art can make some equivalent variations, alterations or modifications to the above-disclosed technical content without departing from the scope of the technical solutions to obtain equivalent embodiments. Any simple alteration, equivalent change or modification made to the above aspects without departing from the content of the technical solutions fall within the scope of the technical solutions of the disclosure.

What is claimed is:

1. A text generation method, comprising:
performing, by a computing device, similarity calculation on each interactive text pair in an interactive content library to obtain at least one target interactive text pair as an annotation example, the annotation example having a corresponding transformation style, the corresponding transformation style being a transformation style between two pieces of interactive text in each target interactive text pair in the annotation example;
performing, by the computing device, semantic similarity retrieval in the annotation example based on text input to obtain a preset number of target annotation examples;
constructing, by the computing device, a prompt according to a target annotation example of the target annotation example, a target style, and the text input, and inputting the prompt into a pretrained language model for performing text extension to obtain at least one piece of predicted text, the target style being a style into which the text input is to be transformed; and
performing, by the computing device, a score calculation on the at least one piece of predicted text to determine target text.

2. The method according to claim 1, wherein the performing similarity calculation on each interactive text pair in an interactive content library to obtain at least one target interactive text pair as an annotation example comprises:
performing first semantic encoding on each interactive text pair in the interactive content library to obtain an interactive text vector of each interactive text pair;
calculating a first semantic similarity of each interactive text pair based on the interactive text vector, the first semantic similarity of each interactive text pair being the first semantic similarity between two pieces of interactive text in the interactive text pair; and
taking at least one target interactive text pair with the first semantic similarity within a first threshold range as the annotation example.

3. The method according to claim 1, wherein the performing semantic similarity retrieval in the annotation example based on text input to obtain a preset number of target annotation examples comprises:
encoding the text input and each of the annotation examples into target vector space to obtain a text vector corresponding to the text input and an annotation example vector corresponding to each annotation example; and
performing semantic similarity retrieval on each annotation example vector based on the text vector to obtain the preset number of target annotation examples.

4. The method according to claim 3, wherein the performing semantic similarity retrieval on each annotation example vector based on the text vector to obtain the preset number of target annotation examples comprises:
performing semantic similarity retrieval on each annotation example vector based on the text vector to obtain a second semantic similarity between the text vector and each annotation example vector;
sorting, according to the second semantic similarity, annotation examples corresponding to all annotation example vectors in descending order to obtain an example rank; and
selecting a preset number of intermediate examples from the example rank based on the descending order, and taking an example in the intermediate examples with the second semantic similarity within a second threshold range as the target annotation example.

5. The method according to claim 4, after the taking an example in the intermediate examples with the second semantic similarity within a second threshold range as the target annotation example, further comprising:
obtaining an example number of the target annotation examples; and
when the example number of the target annotation examples is less than the preset number, performing an example completion operation until the example number of the target annotation examples is equal to the preset number.

6. The method according to claim 5, further comprising:
performing standard problem detection on each target annotation example to determine a target annotation example corresponding to the standard problem; and
performing mutual information calculation on the target annotation example corresponding to the same standard problem to obtain mutual information of two pieces of interactive text in the target annotation example corresponding to the same standard problem; and
comparing values of the mutual information of the two pieces of interactive text, and deleting interactive text corresponding to mutual information having a smaller value from the two pieces of interactive text.

7. The method according to claim 1, wherein the performing score calculation on the at least one piece of predicted text to determine target text comprises:
obtaining a text similarity between each piece of predicted text and the text input based on the text input and second semantic encoding of each piece of predicted text in the at least one piece of predicted text;
performing style prediction on each piece of predicted text based on a language model to obtain style confidence of each piece of predicted text; and
determining the target text from the at least one piece of predicted text according to the text similarity and the style confidence.

8. The method according to claim 7, wherein the obtaining a text similarity between each piece of predicted text and the text input based on the text input and second semantic encoding of each piece of predicted text in the at least one piece of predicted text comprises:
performing second semantic encoding on the at least one piece of predicted text to obtain a predicted text vector corresponding to each piece of predicted text;
performing second semantic encoding on the text input to obtain a text input vector corresponding to the text input;
calculating a semantic similarity between each piece of predicted text and the text input based on the predicted text vector and the text input vector;
calculating a content similarity between each piece of predicted text and the text input based on the predicted text vector and the text input vector; and
determining a text similarity between each piece of predicted text and the text input according on the semantic similarity and the content similarity.

9. The method according to claim 7, wherein the performing score calculation on the at least one piece of predicted text to determine target text comprises:
performing weighted summation on a product of a first weight and the text similarity and a product of a second weight and the style confidence to obtain a selection score;
sorting the at least one piece of predicted text in descending order according to the selection score to obtain a predicted text rank; and
determining the target text from the predicted text rank based on the descending order.

10. An apparatus comprising:
a processor; and
memory storing computer-readable instructions that, when executed by the processor, cause the apparatus to:
perform similarity calculation on each interactive text pair in an interactive content library to obtain at least one target interactive text pair as an annotation example, the annotation example having a corresponding transformation style, the corresponding transformation style being a transformation style between two pieces of interactive text in each target interactive text pair in the annotation example;
perform semantic similarity retrieval in the annotation example based on text input to obtain a preset number of target annotation examples;
construct a prompt according to a target annotation example of the target annotation examples, a target style, and the text input, and inputting the prompt into a pretrained language model for performing text extension to obtain at least one piece of predicted text, the target style being a style into which the text input is to be transformed; and
perform a score calculation on the at least one piece of predicted text to determine target text.

11. The apparatus according to claim 10, wherein the performing similarity calculation on each interactive text pair in an interactive content library to obtain at least one target interactive text pair as an annotation example comprises:
performing first semantic encoding on each interactive text pair in the interactive content library to obtain an interactive text vector of each interactive text pair;
calculating a first semantic similarity of each interactive text pair based on the interactive text vector, the first semantic similarity of each interactive text pair being the first semantic similarity between two pieces of interactive text in the interactive text pair; and
taking at least one target interactive text pair with the first semantic similarity within a first threshold range as the annotation example.

12. The apparatus according to claim 10, wherein the performing semantic similarity retrieval in the annotation example based on text input to obtain a preset number of target annotation examples comprises:
encoding the text input and each of the annotation examples into target vector space to obtain a text vector corresponding to the text input and an annotation example vector corresponding to each annotation example; and
performing semantic similarity retrieval on each annotation example vector based on the text vector to obtain the preset number of target annotation examples.

13. The apparatus according to claim 12, wherein the performing semantic similarity retrieval on each annotation example vector based on the text vector to obtain the preset number of target annotation examples comprises:
performing semantic similarity retrieval on each annotation example vector based on the text vector to obtain a second semantic similarity between the text vector and each annotation example vector;
sorting, according to the second semantic similarity, annotation examples corresponding to all annotation example vectors in descending order to obtain an example rank; and
selecting a preset number of intermediate examples from the example rank based on the descending order, and taking an example in the intermediate examples with the second semantic similarity within a second threshold range as the target annotation example.

14. The apparatus according to claim 10, wherein the performing score calculation on the at least one piece of predicted text to determine target text comprises:
obtaining a text similarity between each piece of predicted text and the text input based on the text input and second semantic encoding of each piece of predicted text in the at least one piece of predicted text;
performing style prediction on each piece of predicted text based on a language model to obtain style confidence of each piece of predicted text; and
determining the target text from the at least one piece of predicted text according to the text similarity and the style confidence.

15. The apparatus according to claim 14, wherein the obtaining a text similarity between each piece of predicted text and the text input based on the text input and second semantic encoding of each piece of predicted text in the at least one piece of predicted text comprises:
performing second semantic encoding on the at least one piece of predicted text to obtain a predicted text vector corresponding to each piece of predicted text;
performing second semantic encoding on the text input to obtain a text input vector corresponding to the text input;
calculating a semantic similarity between each piece of predicted text and the text input based on the predicted text vector and the text input vector;
calculating a content similarity between each piece of predicted text and the text input based on the predicted text vector and the text input vector; and
determining a text similarity between each piece of predicted text and the text input according on the semantic similarity and the content similarity.

16. The apparatus according to claim 14, wherein the performing score calculation on the at least one piece of predicted text to determine target text comprises:
performing weighted summation on a product of a first weight and the text similarity and a product of a second weight and the style confidence to obtain a selection score;
sorting the at least one piece of predicted text in descending order according to the selection score to obtain a predicted text rank; and
determining the target text from the predicted text rank based on the descending order.

17. A non-transitory computer-readable medium storing computer-readable instructions that, when executed, cause an apparatus to:
perform similarity calculation on each interactive text pair in an interactive content library to obtain at least one target interactive text pair as an annotation example, the annotation example having a corresponding transformation style, the corresponding transformation style being a transformation style between two pieces of interactive text in each target interactive text pair in the annotation example;
perform semantic similarity retrieval in the annotation example based on text input to obtain a preset number of target annotation examples;
construct a prompt according to a target annotation example of the target annotation examples, a target style, and the text input, and inputting the prompt into a pretrained language model for performing text extension to obtain at least one piece of predicted text, the target style being a style into which the text input is to be transformed; and
perform a score calculation on the at least one piece of predicted text to determine target text.

18. The non-transitory computer-readable medium according to claim 17, wherein the performing similarity calculation on each interactive text pair in an interactive content library to obtain at least one target interactive text pair as an annotation example comprises:
performing first semantic encoding on each interactive text pair in the interactive content library to obtain an interactive text vector of each interactive text pair;
calculating a first semantic similarity of each interactive text pair based on the interactive text vector, the first semantic similarity of each interactive text pair being the first semantic similarity between two pieces of interactive text in the interactive text pair; and
taking at least one target interactive text pair with the first semantic similarity within a first threshold range as the annotation example.

19. The non-transitory computer-readable medium according to claim 17, wherein the performing semantic similarity retrieval in the annotation example based on text input to obtain a preset number of target annotation examples comprises:
encoding the text input and each of the annotation examples into target vector space to obtain a text vector corresponding to the text input and an annotation example vector corresponding to each annotation example; and
performing semantic similarity retrieval on each annotation example vector based on the text vector to obtain the preset number of target annotation examples.

20. The non-transitory computer-readable medium according to claim 17, wherein the performing score calculation on the at least one piece of predicted text to determine target text comprises:
obtaining a text similarity between each piece of predicted text and the text input based on the text input and second semantic encoding of each piece of predicted text in the at least one piece of predicted text;
performing style prediction on each piece of predicted text based on a language model to obtain style confidence of each piece of predicted text; and
determining the target text from the at least one piece of predicted text according to the text similarity and the style confidence.
